(19) United States
(12) Patent Application Publication
(10) Pub. No.: US 2008/0020883 A1
(43) Pub. Date: Jan. 24, 2008

(54) Chain and method for manufacturing link plates

(75) Inventor: Joachim Sporrer, Erlangen (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/880,099

(22) Filed: Jul. 18, 2007

Related U.S. Application Data
(60) Provisional application No. 60/835,848, filed on Aug. 4, 2006.

(30) Foreign Application Priority Data
Jul. 21, 2006 (DE) 10 2006 033 726.3

(51) Int. Cl. F16G 13/04

(52) U.S. Cl. 474/213; 474/212

(57) ABSTRACT

A method for producing link plates for chains, in particular for toothed chains, wherein the link plates of a plate stack are stamped with their corresponding openings for receiving chain pins or chain sleeves, with at least the openings on one link plate of the plate stack being precision-stamped. Also disclosed is a chain, in particular a toothed chain, having a plurality of hingedly connected chain links that include plate stacks with link plates having corresponding openings for receiving chain pins or chain sleeves, with at least one precision-stamped link plate being provided.

### BACKGROUND OF THE INVENTION

1. Field of the Invention

The present invention relates to a method for manufacturing link plates for chains, in particular for toothed chains, wherein the link plates of a plate stack are stamped with their corresponding openings for receiving chain pins or chain sleeves. In addition, the invention relates to a chain, in particular a toothed chain, having a plurality of hingedly connected chain links that include stacks of plates having link plates with corresponding openings to receive chain pins or chain sleeves.

2. Description of the Related Art

Chains composed of chain links that each include a plurality of link plates as plate stacks are known in various embodiments. Independent of the type of the particular chain, plate stacks with outer plates, inner plates, and middle plates are provided. The link plates, which are situated substantially parallel to each other, have corresponding openings in which chain pins or chain sleeves are held for pivotal attachment of adjacent chain links.

In order to ensure adequate strength in certain applications of the chains, the inner plates and the middle plates, for example, are employed in pairs, so as to increase the mechanical strength of the chain. That increases the width and weight of the chain in a detrimental way. Furthermore, the assembly of such known chains is also more complicated and costly.

Accordingly, an object of the present invention is to provide a method for manufacturing link plates and a chain of the type identified above, which ensure sufficient mechanical strength of the chain, but without the outside dimensions of the chain becoming greater and the assembly more complicated.

### SUMMARY OF THE INVENTION

The object is achieved with regard to the method by having the openings on at least one link plate of the plate stack precision stamped.

By means of the precision stamping, the particular opening on the link plate can be shaped so that the bearing surface areas, i.e., the contacting surfaces of the opening and of the chain pin or chain sleeve that is received and held in the opening, can be enlarged. In accordance with one embodiment of the invention, that result is achieved by reducing the stamped-out portion of each opening to a minimum.

That enables a higher force transmission between the chain pin or sleeve and the link plates. As a result, it is no longer necessary to use pair arrangements of inner and middle plates for reasons of strength, for example.

In that way the dimensions of the chain, and also of the corresponding chain wheel, can be reduced, and thus the overall weight of the components can be reduced. That results in a construction space saving and a weight advantage for the chain manufactured in accordance with the invention.

In addition, the object underlying the development of the invention is also achieved by a chain, in particular a toothed chain, having a plurality of hingedly connected chain links, wherein the chain links include stacks of plates with corresponding openings for receiving chain pins or chain sleeves, and wherein at least one precision-stamped link plate is provided. Preferably, the link plates in the proposed chain are manufactured by the method in accordance with the present invention.

Through the use of precision-stamped link plates it is possible to forego or reduce paired arrangement of the link plates. In that way a chain optimized for construction space and weight is realized.

For example, with the chain in accordance with the invention, in conjunction with one possible embodiment, the plate stacks each have individually situated middle plates and inner plates that are enclosed by outer plates, each of those link plates being precision stamped.

It is also possible for normally stamped link plates to be combined with precision-stamped link plates, in order to further optimize the production costs. For example, a further embodiment of the invention can include the provision that individually situated precision-stamped inner plates and/or middle plates, for example, are combined with middle plates arranged in pairs, or inner plates arranged in pairs.

### BRIEF DESCRIPTION OF THE DRAWING

The structure, operation, and advantages of the present invention will become further apparent upon consideration of the following description, taken in conjunction with the accompanying drawing in which:

FIG. 1 shows a top view of a portion of an embodiment of a toothed chain 1 in accordance with the present invention.

### DESCRIPTION OF THE PREFERRED EMBODIMENTS

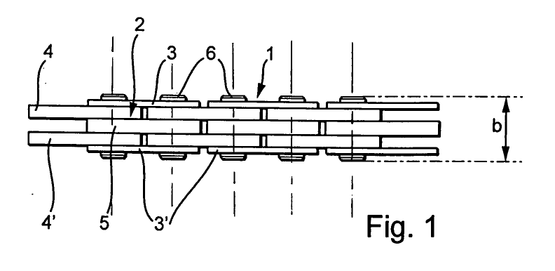

Toothed chain 1 shown in FIG. 1 includes a plurality of hingedly connected chain links, which include plate stacks 2 having a plurality of link plates situated parallel to each other. Each plate stack 2 has two outer plates 3, 3′, which enclose two inner plates 4, 4′ between them. The two inner plates 4, 4′, in turn, enclose a middle plate 5. Each of the link plates 3, 3′; 4, 4′; 5 has two openings for receiving chain pins 6, the openings being indicated by dashed-dotted lines in the drawing figure.

The link plates 3, 3′; 4, 4′; 5 of a plate stack 2 are arranged so that the openings are situated coincident and superimposed relative to each other, so that chain pins 6 can receive all of the link plates 3, 3′; 4, 4′; 5. Thus the link plates 2 of adjacent chain links of toothed chain 1 are hingedly connected with each other.

In the exemplary embodiment of toothed chain 1 as shown, each plate stack 2 includes individually situated link plates 3, 3′; 4, 4′; 5 of the same type. In accordance with the present invention, the outer plates 3, 3′ and the inner plates 4, 4′, as well as the middle plate 5, are produced by precision stamping. That means that no paired arrangement of the link plates 3, 3′; 4, 4′; 5 is provided.

Because all of the link plates 3, 3′; 4, 4′; 5 are produced by precision stamping, the smooth cut part of each link plate 3, 3′; 4, 4′; 5 on the precision stamped opening can be increased in such a way that the bearing surface area can extend over nearly the entire material thickness of each link plate 3, 3′; 4, 4′; 5.

In that way, the level of force to be transmitted can be increased in each link plate 3, 3′; 4, 4′; 5 of the chain in accordance with the invention, without a paired arrangement being necessary. As a result, the total width b of the toothed chain 1 in accordance with the invention can be reduced, so that not only the manufacturing costs but also the required construction space, as well as the total weight of toothed chain 1, can be reduced. Reducing the width of toothed chain 1 also makes it possible to reduce the width of the corresponding chain wheels accordingly, so that the overall weight of the component is reduced.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A method for producing link plates for toothed chains, said method comprising the steps of:
providing link plates for forming a plate stack, wherein the link plates have openings for receiving chain pins; and
stamping the openings of at least one link plate of the plate stack by a precision-stamping process.

2. A method in accordance with claim 1, wherein the precision-stamping process reduces a stamped-out part on each opening to a minimum to provide a larger bearing surface area between chain pins and the link plates.

3. A toothed chain having a plurality of hingedly connected chain links, said chain comprising: a plurality of plate stacks with link plates having corresponding openings for receiving chain pins, wherein at least one precision-stamped link plate is provided in a plate stack.

4. A chain in accordance with claim 3, wherein each plate stack includes at least two precision-stamped outer plates and at least two precision-stamped inner plates that enclose a precision-stamped middle plate.

5. A chain in accordance with claim 3, wherein each plate stack includes at least one normally stamped link plate.
